(19) United States
(12) Patent Application Publication
(10) Pub. No.: US 2006/0074910 A1
(43) Pub. Date: Apr. 6, 2006

(54) Systems and methods of retrieving topic specific information

(75) Inventors: Yeogirl Yun, Mountain View, CA (US); Seong-Gon Kim, Mountain View, CA (US); Rohit Kaul, Palo Alto, CA (US); Marcin Kadluczka, San Jose, CA (US)

Correspondence Address: CARR & FERRELL LLP, 2200 GENG ROAD, PALO ALTO, CA, 94303, US

(73) Assignee: Become, Inc.

(21) Appl. No.: 11/229,090

(22) Filed: Sep. 16, 2005

Related U.S. Application Data
(60) Provisional application No. 60/610,895, filed on Sep. 17, 2004.

(51) Int. Cl. G06F 7/00

(52) U.S. Cl. 707/7

(57) ABSTRACT

The present invention provides systems and methods of searching web pages relevant to a specific topic based on quality of individual pages. The rank of a page for a keyword may be a combination of analytic rank and editorial rank. The analytic rank of a page may be calculated by combining intrinsic and extrinsic ranks. Intrinsic rank is a measure of relevancy of a page to a given keyword as claimed by an author of the page, while extrinsic rank is a measure of the relevancy of a page on a given keyword as indicated by other pages. The former may be obtained from an analysis of keyword matching in various parts of the page while the latter is obtained from context-sensitive connectivity analysis of the link structure of the entire Internet. Methods are described to solve the self-consistent equation satisfied by the page-weights and site-weights in a very efficient iterative way. The ranking mechanism for multi-word query is also described.

### CROSS REFERENCE TO RELATED APPLICATION

The present application claims the priority benefit of Provisional Patent Application Ser. No. 60/610,895, filed Sep. 17, 2004, and entitled “Systems and Methods of Retrieving Topic Specific Information,” which is incorporated herein by reference.

The present application is related to co-pending U.S. application Ser. No. ______, entitled “Systems and Methods of Retrieving Topic Specific Information,” filed on Sep. 17, 2005.

### BACKGROUND OF THE INVENTION

1. Field of the Invention

The present invention relates generally to information searching, and more particularly to Internet search engines.

2. Description of Related Art

General purpose Internet search engines, like Google™ (www.Google.com), are good at finding information like site names, people names, and research papers. In other words, these search engines do a relatively satisfactory job in finding relevant information associated with a topical domain that may be readily expressed in the form of a query. However, these search engines do not fare well when the information sought is a part of a well-defined topical domain that may not be easily expressed in the form of a query. In one example, suppose a user desires to purchase a digital camera. The user searches “digital camera” on Google™. As of May 21, 2004 (Google™ Search digital camera.htm), seven of the top ten results are not pages to purchase digital cameras, but rather product review pages. Further, the emusicLive site (www.dcn.com)—which is irrelevant to digital cameras—claims the 9th slot.

Users may attempt to fine-tune their searches by adding more keywords such as “digital camera shopping” or “digital camera buy.” These “advanced” queries, however, often do not significantly improve the results and may eliminate too many relevant and shopping-related pages. Shopping is a well-defined domain that is associated to other information such as purchasing, ordering, product review, product description, merchants, and customer service in a coherent fashion. Yet it is very hard or practically impossible to express it in terms of queries.

Another problem is link structure manipulation. Most of the Internet search engines in operation today use one of the variations of link structure analysis. The PageRank™ algorithm used by Google™ is a good example. Google's algorithm is the first one to harness the power of link structure analysis and proved itself very effective in defending against the conventional keyword-based spamming attacks. However, PageRank™ is susceptible to a class of clever spamming techniques that manipulates the link structure of the Internet. Webmasters and so-called “search engine engineers” have learned how PageRank™ works and figured out how to manipulate its algorithm. One such technique is “Google bombing” and has given Google™ many cases of unwanted publicity. See for example, http://www.wired.com/news/print/0,1294,41401,00.html and http://www.microcontentnews.com/articles/Googlebombs.htm.

The main reason that Google bombs work is due to the fact that the keywords from an anchor text of a referring page is “attached” to the referred page, whether an owner of a target page agrees or not. For this reason, in some embodiments, the anchor text is not simply attached to the referred page.

Anchor text is a section of text, an icon, picture, link, data, or other element in a web page that links to another web page or file. In one example, the anchor text is a portion of a web page that is activated (e.g. by a mouse click) to access another web page or file. In a further example, the anchor text comprises a URL.

Another less known, but potentially more damaging technique to manipulate PageRank™ is called “artificial web”. With a moderate investment, spammers may purchase a few IP addresses and large storage spaces. The spammers may then easily write scripts to generate millions or even billions of simple web pages that contain links to a few web sites to be promoted. As the number of these artificial web pages is greater than the number of web pages with valid links, the spammers may wield undue influence in manipulating the link structure, thereby affecting the PageRank™ computation.

The vulnerability against “artificial web” manipulation reveals the fundamental limitation of conventional link analysis algorithms such as Google's PageRank™. The conventional link analysis equally treats all web pages on the web. A web page from Yahoo!™ site may be counted equally as a web page from an obscure website maintained by a fourth-grader. This makes it possible for an artificial web to substantially alter the PageRank™ results.

### SUMMARY OF THE INVENTION

The present invention relates to systems and methods of information retrieval within a specific topic. In one embodiment, a search engine and a method produces relevant search results to keyword queries. The search engine includes a crawler to gather pages, indexer(s) to extract and index URLs of pages with keywords into index data structure(s), and a ranker to rank hypertext pages based on intrinsic and extrinsic ranks of the pages based on content and connectivity analysis. Page-weights may be calculated based on an iterative numerical procedure including a method for accelerating convergence of scores. The search engine may also rank pages based on scores of a multi-keyword query. The ranking scores may be based on using an entire set of hypertext pages and/or a subset based on topic or the like.

One embodiment of the present invention provides a crawler and a method to visit sites and collect web pages only relevant to a specific topic. This embodiment of the present invention enables the search engine to naturally focus on the specific topic without excluding many relevant web pages by using explicit keywords.

One embodiment of the present invention provides a general-purpose search engine and a method to rank the pages according to quality of individual pages. This embodiment of the present invention enables the search engine to present the search results in such a way that most relevant results appear on top of the list.

### BRIEF DESCRIPTION OF THE DRAWINGS

FIG. 1 is an exemplary architecture of a search engine according to one embodiment.

FIG. 2 is an exemplary architecture of a ranker of the search engine according to one embodiment.

FIG. 3 is a method performed by the page-weight generator of the Yrank generator according to one embodiment.

### DESCRIPTION OF EXEMPLARY EMBODIMENTS

A search engine collects, stores, indexes, and ranks web pages in response to search queries. Yrank is a search technique that relates to retrieving relevant web pages, icons, images, video, audio, text, or other data within a specific topic from hypertext page collections such as the Internet. One of ordinary skill will understand after review of the specification that the search engine that utilizes Yrank may be used on many other collections of hypertext pages.

Yrank takes advantage of coherence in a given topical domain by finding web pages with a certain keyword, and may employ several new link analysis techniques. Search engines that use Yrank may not need to crawl the entire web; they may crawl topic-specific web pages, such as shopping related web pages. Topic-specific crawling has many advantages over general crawling. For example, the number of topic-specific web pages may be considerably less than the number of web pages available on the Internet (e.g. it is estimated that no more than 5% of the entire Internet is shopping-related). With a reduced size, computation cost will be greatly reduced.

Yrank may contribute to searches that are more precise than general-purpose search engines. For example, Yrank may define a “topic” in a well-defined and sophisticated method to focus its crawling. As a result, this focus may be more precise and inclusive than complex queries through a general-purpose search engine. Consequently, the results may be more relevant and contain less noise.

Crawlers in Yrank systems exhaustively collect topic-related pages. As a result, a Yrank database may contain more web pages in one topical domain than that of general-purpose search engine, thereby producing a search result with high recall rates. Search engines that utilize Yrank may collect web pages within a database that are focused on particular topics. Although the total size of the database may be smaller than that of general-purpose search engines, the depth of the database may be deeper.

Yrank uses a technique to evaluate a proper weight factor for each anchor text. The more trustworthy a referring page is, the more Yrank may trust the anchor text. This process allows one of the most powerful defenses against link structure manipulations such as Google bombs.

The equilibrium of page-weight distribution among nodes is computed using page-weight. A “page-weight reservoir” may overcome limitations of PageRank™. The page-weight reservoir comprises virtual incoming links from many web pages on the Internet and outbound links to a few major well-known “sites” (see below), termed “reservoir nodes”. The artificial web may receive no weight from the page-weight reservoir and consequently, the entire artificial web may share a tiny weight assigned to its top few web pages. In other words, regardless of the total number of web pages generated in the artificial web, the weight of the targeted web page may not change.

A site, another concept used by Yrank, comprises a same meaning as a web site in the Internet and may be extended to include any group of web pages that shares a parent web page—with that web page included. This new abstraction adds a new layer in a graph, making two layers, one for sites and another for web pages. The page layer computes an equilibrium of page-weight distribution among the nodes. The site layer employees a similar ranking scheme to compute an equilibrium of an endorsement distribution among the sites. Combined with the concept of page-weight reservoir, this newly introduced site layer may make it virtually impossible to manipulate Yrank scores for a few targeted pages. Every web page may belong to a certain site in the Yrank system. Even though a targeted page may receive many artificially created links from authority (high score) pages, site score for the site containing the target page may be low, thereby making the target page's score low.

Another benefit from this site-oriented abstraction may be identifying mirror sites. Mirror sites have the same structural design, such as out-going links. If two sites have a very similar link structure (e.g., same number of out-going links to the same set of different sites), they may likely be mirror sites.

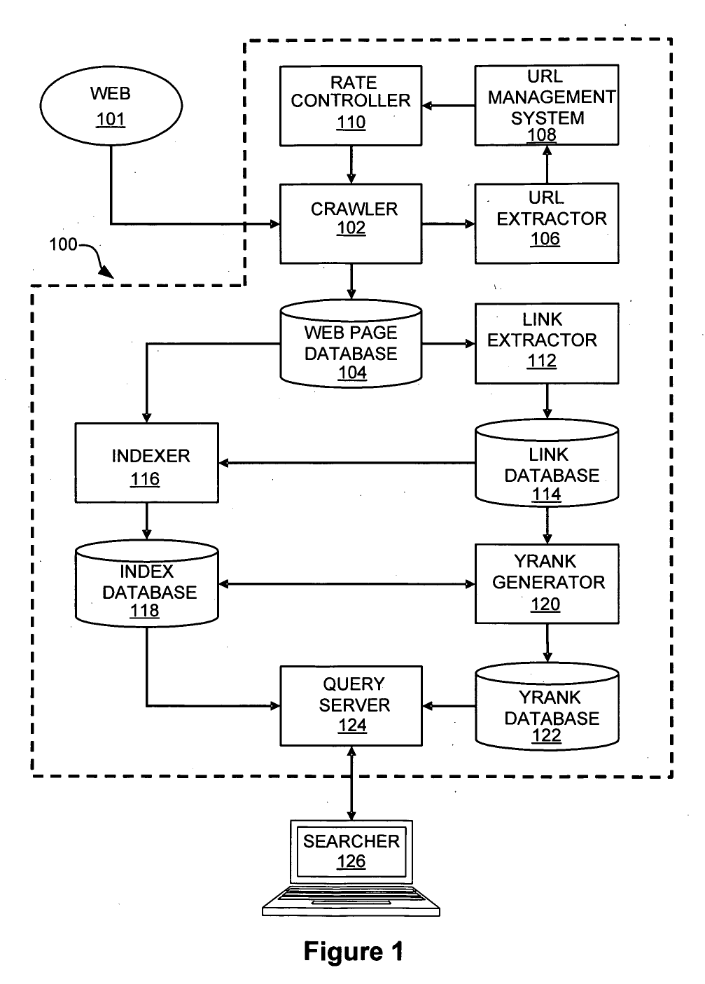

FIG. 1 is an exemplary architecture of a search engine 100 according to one embodiment. The search engine 100 may receive a request for one or more web pages from searcher 126. The searcher 126 may be any digital device configured to browse web pages and/or search the Internet. Examples of the searcher 126 are personal computers, personal digital assistants, cellular telephones, and notebook computers. The search engine 100 may retrieve one or more web pages from the web 101. The web 101 is any globally accessible network, including, but not limited to the Internet, an extranet, or an intranet.

The exemplary search engine 100 comprises a crawler 102, a web page database 104, a universal resource link (URL) extractor 106, a URL management system (UMS) 108, a rate controller 110, a link extractor 112, a link database 114, an indexer 116, an index database 118, a Yrank generator 120, a Yrank database 122, and a query server 124. In some embodiments, the search engine 100 is written in Java and runs on the Linux operating system using suitable Intel Pentium processors. Those skilled in the art will appreciate that any hardware, operating system, or combination of hardware and operating system may be used.

The exemplary crawler 102 fetches web pages from the web 101. Multiple instances of the crawler 102 may be executed to increase the crawler 102 capacity to crawl through hypertext document collections such as web pages on the web 101. The crawler 102 stores the fetched web pages within the web page database 104. The crawler 102 may also send any URL or anchor text within the fetched web pages to the web page database 104. The web page database 104 comprises data structures configured to store the fetched web pages. In some embodiments, the data structures within the web page database 104 are optimized for fast access of the fetched web pages.

The crawler 102 may further send the fetched web pages to a URL extractor 106. The URL extractor 106 finds URLs (e.g., outbound links) in the fetched web pages and send the URLs to the URL Management System (UMS) 108. A URL may be any link to data, a web page, an article, text, an image, an audio file, and/or a video file. In some examples, the URL is a source URL. A source URL is any URL that identifies a source for data, article, text, image, audio file, and/or video file within a web page. In other examples, the URL may be a destination URL. A destination URL is any URL within a web page that is a link to other data or another web page.

The UMS 108 may assign an identification number to each URL. The UMS 108 may also maintain a database that stores the individual identification numbers and URLs. In some embodiments, the UMS 108 associates one or more identification numbers to one or more URLs. In one example, the UMS 108 stores the associations within a hash table. In other embodiments, the UMS 108 stores the individual identification numbers, URLs, the URL's anchor text, and/or associations within the web page database 104.

The UMS 108 may check each URL to determine if the URL is already within the database. If the UMS 108 determines that the URL is not within the database, the UMS 108 may store the URL within the database and also sends the URL to the web page database 104. The UMS 108 may send the URLs through the rate controller 110. In some embodiments, the UMS 108 sends the URLs to the crawler 102 which writes the URL to the web page database 104.

The exemplary rate controller 110 buffers the URLs received from the UMS 108 and sends the URLs to the crawler 102. In some embodiments, the rate controller 110 determines each site associated with each individual URL received from the UMS 108.

The rate controller 110 may also determine if the site has received a crawling request within a predetermined period of time. If the site has received a crawling request within the predetermined period of time, then the rate controller 110 may not send the individual URL to the crawler 102. If the site has not received a crawling request within the predetermined period of time, then the rate controller 110 may send the individual URL to the crawler 102. In one example, the rate controller 110 receives a URL from the UMS 108. The rate controller 110 determines that the URL identifies a site that has received a crawling request within the predetermined period of time. As a result, the rate controller 110 does not forward the URL to the crawler 102.

In other embodiments, the UMS 108, the URL extractor 106, or the crawler 102 determines if the site of the individual URL has received a crawling request within a predetermined period of time. In some embodiments, the process of determining if the site has received a crawling request within a predetermined period of time prevents the site from getting excessive crawling requests.

In exemplary embodiments, the link extractor 112 retrieves fetched web pages from the web page database 104 and write URLs, identification numbers, and associated anchor text to the link database 114. The indexer 116 may extract the anchor text from the link database 114, parse one or more keywords from the web page database 104, and generate an index database 118. The indexer 116 may also store each keyword and its associated list of URL identification numbers in the index database 118. In one example, the index database 118 is configured to allow devices and software to quickly retrieve the keywords and/or identification numbers.

In some embodiments, the search engine 100 ranks the pages. In exemplary embodiments, the Yrank generator 120 reads the link structure from the link database 114, calculates the page-weight, reads the indexed words (e.g., keyword) from the index database 118, and calculates the rank value for each keyword and page pair. The Yrank generator 120 may store the page-weight and the rank values in the index database 118. The Yrank generator 120 may also build a Yrank database 122 as a subset of the index database 118 for a single keyword query. The Yrank generator 120 is referred to herein as a ranker.

In some embodiments, the search engine 100 responds to a search query with search results in order of relevancy. The exemplary Yrank generator 120 measures the relevancy of each web page by examining the web page's content, the page-weight, the weight of the links to the web page, and the weight of the linking pages. The words, font size, and position of the words may define the content of the web page. For example, the Yrank generator 120 may compare the font size of each word relative to other words in the web page to determine the importance of the word. The position of the word in the web page also may matters. For example, if the word is in the title, it may be desirable to give the word more weight than if the word appears at the bottom of the web page. The popularity of the web page may be determined by page-weight and site-weight. Page-weight and site-weight are the probability of visitors viewing the page and site, respectively. The Yrank generator 120 may determine the intrinsic rank of the page from the content score and the page popularity.

The Yrank generator 120 may measure the weight of the links to the web page by examining the text associated with the link such as the anchor text. In one example, the Yrank generator 120 gives more credit to a link from a web page with the keyword in the anchor text. The Yrank generator 120 then determines the extrinsic rank of the web page from the link-weight and the page-weight.

When the exemplary query server 124 receives a query from a searcher 126, the query server 124 collects the relevant web pages from the Yrank database 122 and index database 118. If the Yrank database 122 and/or the index database 118 is large, the web pages may be stored across multiple instances of search nodes. Each search node in the query server 124 may collect a fixed number of the most relevant results from the Yrank database 122 and/or the index database 118 and returns the results to the query server 124. The query server 124 then sorts and ranks the results from these different nodes and presents the most relevant results.

Yrank

In one embodiment, the overall rank of a web page is expressed in the following form:
YR=YR(p,s,q;t)
meaning that the rank of a web page is a function of its page (p), site (s), and a query (q) and topic (t) in question. In another embodiment where the ranking algorithm is used to rank the web pages in a specific topic, the topic parameter t is fixed (e.g.,, “shopping”) and will be dropped from the following discussions.
Page-Weight

Page-weight of a web page is defined as a probability for a user —who travels on the Internet endlessly in a random but well-defined manner—to visit the web page. The user may operate the searcher 126 and/or the search engine 100. If a web page has high probability to be visited by the user, the web page is more likely to be a well-known web page and to have many links from other web pages (e.g., CNN™, Amazon™).

In one embodiment, the page-weight may be calculated by adding a hypothetical web page, termed a page-weight reservoir to a collection of web pages. A link from every web page is made to the page-weight reservoir. The page-weight reservoir, however, has outbound links to only a few pre-determined “important” top-level web pages, termed reservoir nodes. There are two different kinds of web pages: leaf web pages that have no outbound links and stem web pages that have at least one outbound link to a web page in the collection. The page-weight reservoir acts as a destination for leaf web pages. The page-weight reservoir may solve the problem of web pages pointing only to each other producing a loop, which traps the user. The page-weight reservoir may also ensure the conservation of total page-weight in the collection of web pages.

In some embodiments, the user complies with certain rules in moving from web page to web page. In one example, at each step, the user chooses an outbound link randomly and follows it to other web pages. If the user comes to the web page-weight reservoir, the user immediately chooses an outbound link randomly to the other web pages. Consequently, each move from web page to web page is independent from prior history and only depends on the current web page.

For example, let LW(b→a) denote the link-weight, that is, the probability of choosing a particular outbound hyperlink to web page a out of all outbound links originating from web page b. The probability that the user visits page a at step n after visiting web page b through the link b→a is L W(b→a)•Pₙ₋₁(b), where Pₙ₋₁(b) denotes the probability that the user visits page b at step n-1. Thus, the probability of the user visiting web page a at step n of the random walk, Pₙ(a), by collecting the contributions from all other web pages is as follows:

$${P}_{n} ( a ) = {\sum }_{b} LW ( b \to a ) \cdot {P}_{n - 1} ( b )$$

This equation only applies to actual web pages even though the summation variable b includes the page-weight reservoir R.

The probability for the user to make a random jump via the page-weight reservoir R as is follows:

$${P}_{n} ( R ) = {\sum }_{a \neq R} LW ( a \to R ) \cdot {P}_{n} ( a )$$

Note that the same iteration indices n are used on both sides of the equation, unlike the equation for the actual web pages.

If the user continues to move from web page to web page, eventually the probability of visiting web page a will reach an equilibrium value. Page-weight of web page a is defined as this equilibrium probability:
PW(a)=lim_{n→∞}Pₙ(a)

Thus, a self-consistent equation for the page-weight is obtained:

$$PW ( a ) = {\sum }_{b} LW ( b \to a ) \cdot PW ( b )$$

Note that a sum includes the contribution from the page-weight reservoir R.
Link-Weight

Link-weight is the probability the user will choose a particular outbound hyperlink out of all outbound links originating from a web page. Link-weight may also represent the importance of the link. In one embodiment, all link-weights from a given web page a may have a uniform value corresponding to 1/Nₒᵤₜ(a), where Nₒᵤₜ(a) is the total number of links outbound from web page a, including the extra link to the page-weight reservoir. Therefore, Nₒᵤₜ(a) is greater than or equal to one for every web page and there is no terminal web page in the collection. In another embodiment, a certain fixed fraction is given to the link-weight to the page-weight reservoir. Regular links share the remaining fraction of the link-weight. In yet another embodiment, not every outbound link is equally important. Thus, we give each link a different weight depending on several factors such as the offset of the link (i.e., position on the web page) and the size of the paragraph where the link is located.

In another embodiment, a link readily visible upon the loading of a web page may have a higher link-weight than one visible only after scrolling down. The search engine 100 may also assign different weights for external links (i.e., links that point to web pages in other site) and internal links (i.e., links that point to web pages in the same site). Many times the internal links serve simply as a navigational tool rather than leading to new subjects represented by the anchor texts. The sum of all link-weights from a web page is equal to one:

$${\sum }_{b} LW ( a \to b ) = 1$$

If there is no link from one web page to another, the corresponding link-weight is zero.

Site-Weight

Site-weight is similar to page-weight:

$$SW ( A ) = {\sum }_{B} SLW ( B \to A ) \cdot SW ( B )$$

Here, SLW(B→A) denotes the site link-weight, the weight of the connection from site B to site A. In one embodiment, the site link-weight is obtained by summing the link-weights from web page b (all web pages in site B) to a (all web pages in site A).

$$SLW ( B \to A ) = {\sum }_{a ∈ A , b ∈ B} LW ( b \to a )$$

Page Popularity

The popularity of a web page is determined by page-weight and site-weight. In one embodiment, the web page popularity is calculated by adding two weight factors:
PP(p)=log₂[PW(p)]+p₁·log₂[SW(SITE(p))]

The function SITE(p) returns the site that the given web page belongs to. The adjustable parameter p₁ controls the weight of SW over PW.

The justification of using logarithm with base 2 is as follows. The difference of page-weight or site-weight between “good” and “bad” web pages is very large and changes over several orders of magnitude. To construct a meaningful page popularity score, a logarithm needs to be used. In one embodiment, base 2 logarithm is approximated without costly computations by extracting the bits representing the exponent of the floating numbers.

In another embodiment, the page popularity is calculated by taking a harmonic mean of the logarithm of two weight factors:

$$PP ( p ) = 2 \frac{{log}_{2} [ PW ( p ) ] \cdot {log}_{2} [ SW ( SITE ( p ) ) ]}{{log}_{2} [ PW ( p ) ] + {p}_{1} \cdot {log}_{2} [ SW ( SITE ( p ) ) ]}$$

The advantage of this embodiment is that when both page-weight and site-weight are high, the page popularity is assigned to a high value. If either one of the weight is small, the resultant page popularity is also small.

Query

A query is formed by a combination of keywords. For example, the query “digital camera” is made of two keywords, “digital” and “camera”. The relationship of these keywords may be interpreted in various ways depending on the user's intention. In one case, the user is looking for documents with the exact phrase, “digital camera”. In the other case, the user is looking for documents that contain both keywords “digital” and “camera”. In the first case, the query may be interpreted as a QUOTATION resulting in a very restricted match. In the second case, the query needs to be interpreted as AND. Most search engines treat a multiple keywords query as an AND operation, and require the first case to be surrounded by quotation marks. In reality, however, most users do not want a pure AND operation when they type “digital camera”. They want these keywords to appear as close as possible, while retaining all other documents that do not contain the exact phrase. Therefore, the proximity of the keywords needs to be considered. Furthermore, the proximity has to be directional: “digital camera” and “camera digital” should be treated differently.

Two-keyword queries are discussed herein. One of ordinary skill, however, would understand that the generalization to queries with more than two keywords is straightforward.

Components of Yrank

In one embodiment, the Yrank generator 120 calculates the rank of web pages as the combination of two rank scores:
YR(p,Q)=AR(p,Q)+y₁˜ER(p,Q)

Here y₁ is an adjustable constant that controls the weight of the editorial rank (ER) over the analytic rank (AR). Both editorial rank (ER) and analytic rank (AR) will be discussed in more detail herein.

Analytic Rank

In one embodiment, the analytic rank AR of a web page p for a query Q is obtained from a query combination function:
AR(p,Q)=QC[AR(p,K₁),AR(p,K₂)]

Here K₁ and K₂ are two keywords in the query Q, and QC(K₁, K₂) is a query combination function. This function determines how the analytic ranks for each keyword in the query may be combined.

Ouery Combination Function

In one embodiment, the query combination function QC(K₁, K₂) for a two-keyword query is determined by:
QC(K₁,K₂)=AR(K₁)+DAMP[PROX(K₁,K₂)]·AR(K₂)

Here, DAMP(x) is a weight damping function and PROX(K₁, K₂) is the proximity index of two keywords K₁ and K₂. The proximity index may be calculated by the offsets of two keywords. If the keyword K₂ appears before K₁, the proximity index will be negative.
PROX(K₁, K₂)=OFFSET(K₂)−OFFSET(K₁)
Damping Function

Damping function DAMP(x) determines the weight damping factor as a function of proximity index x. In one embodiment, DAMP(0) is meaningless (two different keywords may not have the same offset values) and DAMP(1) is assigned to have a constant maximum value. In another embodiment, after a certain distance (e.g., 100), DAMP(x) remains constant at the minimum value (e.g., 0.1). In one example, DAMP(x) decays a lot faster for negative values (preferring the result with keywords in the right order).

DAMP(x) may be implemented using a table. In another embodiment, DAMP(x) is implemented using a formula. One such formula is:
DAMP(x)=(d₁−d₂)exp[(1−x)/d₃]+d₂, for x≧1.

The adjustable parameters have the following meaning:
d₁ is a maximum value at x=1, or DAMP(1)=d₁.
d₂ is an asymptotic at large x, or DAMP(∞)=d₂.
d₃ is a damping length. It controls how fast the function value drops from its maximum to its minimum. At x=1+d₃, the function value will drop by about 63% of its maximum value d₁.

A similar damping function may be defined for negative proximity values. A smaller d₁ and d₂ and bigger d₃ may be chosen to promote documents with keywords appearing in the right order.

Analytic Rank for a Keyword

The analytic rank of a web page p for a keyword K is calculated by combining the intrinsic rank (IR) and extrinsic rank (XR) of the web page:
AR(p,K)=IR(p,K)+y₃* XR(p,K)
Here y₃ is an adjustable constant parameter that controls the weight of XR over IR.
Intrinsic Rank

Intrinsic rank is a measure of importance of a web page for a given keyword as claimed by an author of the page. Importance may be measured by examining the content of the web page, (e.g., the appearance of the keyword in the title or headings or body of the text). However, as anyone with experience in search engine would know, this may be misleading and aggressively manipulated. Some sites exaggerate the importance of their web pages by repeating “hot” keywords endlessly without adding any value to the content of the page. In one embodiment, the author's claim is respected as much as the web page is worth. If the web page is highly respected and frequently cited, we value the author's claims more, and if otherwise, less. One solution is to use the page popularity:
IR(p,K)=C(p,K)·PP(p)

Here C(p,K) represents the content score of web page p for keyword K and PP(p) represents the page popularity for web page p.

In another embodiment, the intrinsic rank is calculated by taking a harmonic mean of the content score and page popularity:

$$IR ( p , K ) = 2 \frac{C ( p , K ) \cdot PP ( p )}{C ( p , K ) + PP ( p )}$$

The advantage of this embodiment is that when both content score and page popularity are high, the intrinsic rank is assigned to a high value. If either the content score or page popularity is small, the resultant intrinsic rank may also be small.

Content Score

The content score may be calculated in many ways. One such example is:
C(p,K)=C_{T}·T(p,K)+cₚ·P(p,K)+c_{U}·U(p,K)
Where the variables are defined as follows:
T(p,K)=1 if keyword K is found in the title of the page p and 0 otherwise.
P(p,K) represents the frequency of the keyword K in the plain text of page p.
In one embodiment, P(p,K) is capped at a pre-determined maximum value (e.g., 1) to prevent spamming. Plain text means text in the page excluding the title.

U(p,K)=1 if keyword K is found in the URL of the page and 0 otherwise.

Parameters c_{T}, c_{P} and c_{U} represent relative importance of the title, the plain text, and the URL field, respectively.

Extrinsic Rank

Extrinsic rank is a measure of relevancy of a web page for a given keyword as indicated by other web pages. It measures authoritativeness of a page on a given topic or keyword as regarded by the public. Once the page-weight is obtained, the extrinsic rank may be calculated for each keyword and web page pair. In one embodiment, the extrinsic rank is defined as follows:

$$XR ( p , K ) = {log}_{2} [ {\sum }_{b} AW ( b \to a , K ) \cdot PW ( b ) ]$$

Here, A W(b→a,K) is the anchor-weight. It represents the weight given to the anchor text found in page b linking to page a for a given keyword K.

The equation multiplies the anchor-weight of a link by the page-weight of the originating page and sums each product for all fetched web pages. The anchor-weight may be set in many different ways. The anchor text for a given link is useful for setting the anchor-weight. We may also consider the related text of the page, which is either nearby the anchor text and/or related to the same topic. Thus, related headings, text in the vicinity of the anchor, and other anchor text on the same page may be useful for setting the anchor-weight.

In one embodiment, we set AW(K;b→a)=LW(b→a) if the keyword is found in the anchor text, and zero if not.

For computing the extrinsic rank, XR(p,K), we need to also introduce the concept of partial extrinsic rank (described further herein).

The partial extrinsic rank is defined as:

$$PXR ( p , UA ) = {\sum }_{c} AW ( c \to p ; UA ) \cdot PW ( c )$$

Where web page c represents all web pages, which contains link to web page p with the identical anchor text, UA. In other words, contributions to extrinsic rank from all pages with identical anchor text are collected into one partial extrinsic rank, which saves computational resources when calculating proximity value. Thus, the partial extrinsic rank is very useful for a multi-keyword query.

In another embodiment, partial extrinsic rank may be used for a single keyword query, and the extrinsic rank will be the sum of partial extrinsic ranks over the identical anchor text:

$$XR ( p , K ) = {\sum }_{UA ( K )} PXR ( p , UA ( K ) )$$

Here UA(K) denotes the identical anchor text containing keyword K.

In one embodiment, the Yrank generator 120 uses the partial extrinsic rank to obtain the extrinsic rank for a multi-keyword query in the following manner:

$$XR ( p , {K}_{1} , {K}_{2} ) = {\sum }_{UA ( {K}_{1} , {K}_{2} )} PXR ( p , UA ( {K}_{1} , {K}_{2} ) ) \cdot PROX ( {K}_{1} , {K}_{2} ; UA ( {K}_{1} , {K}_{2} ) )$$

UA(K₁, K₂) is the identical anchor text containing both keywords K₁ and K₂. PROX(K₁, K₂; UA(K₁, K₂)) is the proximity value of the keywords K₁ and K₂ within the identical anchor text UA(K₁,K₂). To facilitate the extrinsic rank calculation of a multi-keyword query, the index database 118 contains a field to store the partial extrinsic rank for each identical anchor text and stores all offsets for each keyword in the anchor text. Therefore, to calculate the extrinsic rank for the multi-word query, the entry for K₁ and K₂ in index database 118 is found. For each web page, there will be a list of identical anchor text each with an identification number, the offset of the keyword in the anchor text, and the partial extrinsic rank. From the identical anchor text identification number and offset, the Yrank generator 120 may obtain the proximity value. The Yrank generator 120 also collects the product of partial extrinsic rank and proximity value.

In another embodiment, the Yrank generator 120 associates a list of related words for selected broad topic keywords, such as “science” or “sports”. In this way, the problem of synonyms may be solved, such as finding the web pages for “automobile” when querying with “car.”

The related words table may be as follows:

| Word | Related words |
|---|---|
| Automobile | {<auto, 1.0>, <car, 1.0>, <truck, 0.9>, . . .} |
| Sports | {<football, 1.0>, <basketball, 0.9>, <tennis, 0.9>, . . .} |
| . | . |
| . | . |
| . | . |

The numbers in the table may be used for the anchor-weight. Using these tables, when the extrinsic rank for “automobile” is calculated, for example, the keyword “car” is collected at the same time. Further, the anchor text containing “truck” contributes, but with less weight.

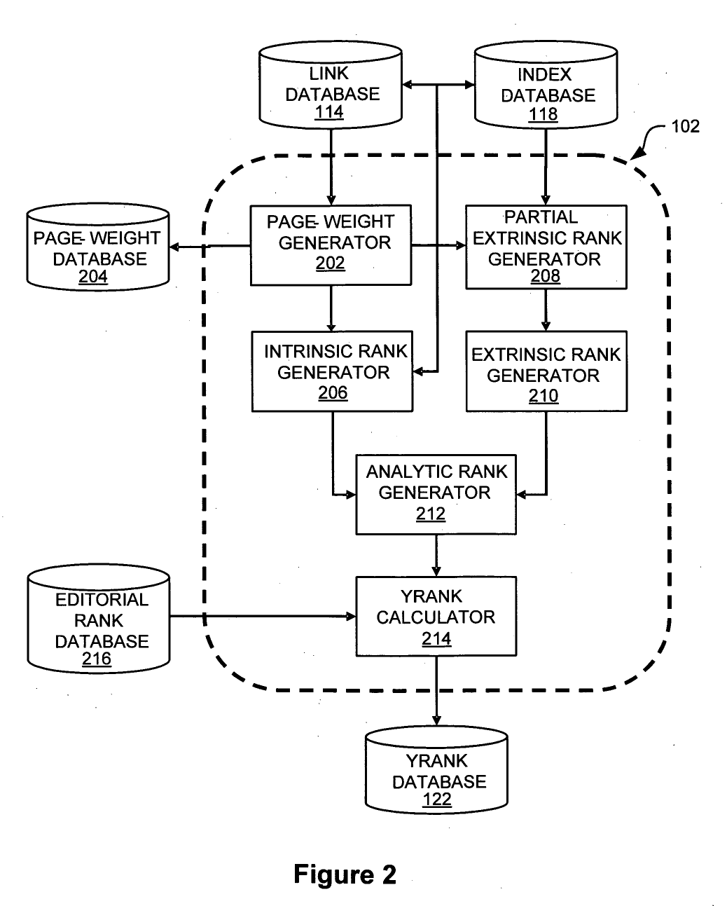

FIG. 2 is an exemplary architecture of the Yrank generator 120 of the search engine 100 (FIG. 1) according to one embodiment. The exemplary Yrank generator 120 comprises a page-weight generator 202, an intrinsic rank generator 206, a partial extrinsic rank generator 208, an extrinsic rank generator 210, an analytic rank generator 212, and a Yrank calculator 214.

The page-weight generator 202 may retrieve fetched web pages from the link database 114, calculate the page-weight for the fetched web pages, and store them in the page-weight database 204. The page-weight database 204 is any database configured to receive and store web pages and/or page-weight.

The exemplary intrinsic rank generator 206 reads the index database 118 to calculate a content score and combines the content score with the page-weight read from the page-weight database 204 to calculate the intrinsic rank for a given keyword and URL pair. The intrinsic rank generator 206 may read one keyword at a time from the index database 118. The exemplary index database 118 stores a set of records where each record includes the URL identification number and bit fields to indicate the presence and proximity of a given keyword in the title, the anchor text of the inbound link, text related to the anchor text as described earlier, in the plain text, and/or in the URL of the web page. Another bit field of the record may be set when the URL is the top-level of a given host.

The partial extrinsic rank generator 208 may read several input files including, but not limited to, files from the link database 114, the index database 118, and the page-weight database 204. The partial extrinsic rank generator 208 may also calculate the partial extrinsic rank values for each identical anchor text and URL pair. The partial extrinsic rank generator 208 may write the resulting partial extrinsic rank to the index database 118. In some embodiments, the partial extrinsic rank may be used for extrinsic rank for single and multi-word query.

The exemplary extrinsic rank generator 210 collects the partial extrinsic rank for each keyword and URL pair. In the case of a multi-keyword query, the extrinsic rank generator 210 collects all partial extrinsic ranks for identical anchor text containing the keywords produced by partial extrinsic rank generator 208. In one embodiment, the analytic rank generator 212 combines intrinsic and extrinsic ranks to produce the analytic rank value, for each keyword and URL pair. The Yrank calculator 214 reads the editorial rank database 216 and combines the editorial rank with the analytic rank to get the final Yrank scores. The Yrank calculator 214 also may collect the top-ranked URLs (e.g., top 400 URLs) and store them in the Yrank database 122 in descending order.

Editorial Rank

Editorial rank ER(p,Q) represents the relevance feedback of page p and query Q. In one embodiment, editorial rank includes contributions from user-click-through UER(p,Q) as well as the expert relevance feedback XER(p,Q), usually provided by the maintainer of the search engine:
ER(p,Q)=UER(p,Q)+e₁·XER(p,Q)
Page-Weight Calculation

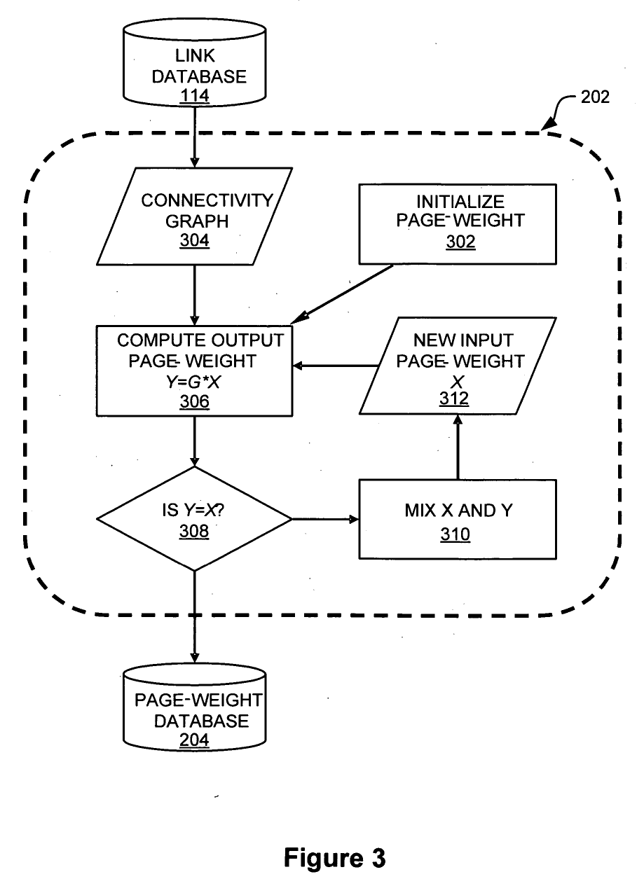

FIG. 3 is a method performed by the page-weight generator 202 of the Yrank generator 120 (FIG. 1) according to one embodiment. In step 302, the page-weight vector X is initialized to a constant such as 1. In step 304, the connectivity graph G, representing the link structure of all of the fetched web pages, is constructed from the link database 114 (FIG. 1).

In step 306, the output page-weight vector is determined based on the connectivity graph G and the initial page-weight vector X from step 302. In step 308, the output page-weight vector Y is tested for convergence. If the output page-weight vector Y is satisfactorily close to the initial page-weight vector X within a predetermined tolerance, typically in the order of 10⁻⁶, then the iteration stops and the final page-weight vector is written to the page-weight database 204. If the convergence is not achieved, the page-weight generator 202 continues to step 310.

In step 310, the page-weight vector X and the output page-weight vector Y are mixed. In one example, the page-weight vector X and the output page-weight vector Y may be mixed by a mixer module. In step 312, a new input page-weight vector X is determined based on the mixing of the page-weight vector X and the output page-weight vector Y. The page-weight generator 202 returns to step 306 where the iterative process repeats using the new input page-weight X in place of the initial page-weight X until convergence is reached.

We may use a normalized error function to measure the convergence in step 308:

$$e = \frac{{\sum }_{i} {( {y}_{i} - {x}_{i} )}^{2}}{{( {\sum }_{i} {x}_{i} )}^{2}}$$

Where xᵢ and yᵢ represent the components of the input page-weight vector X and output page-weight vector Y.

As explained below, in one embodiment, the extended Anderson Mixing method calculates the page-weights iteratively as described in V. Eyert, A Comparative Study on Methods for Convergence Acceleration of Iterative Vector Sequence, J. Comp. Phys. 124, 271-285 (1996), the disclosure of which is incorporated by reference. By analyzing the history of the mixing and the response of the system during a few past iterations, the system teaches itself to construct the next input vector in the most efficient way. The mixing scheme may achieve the same accuracy in about seven iterations for what appears to normally take others more than 200 iterations.

The page-weight for the fetched pages may be found by solving the following matrix equation:
X=G·X

X is a (N +1)×1 column matrix representing the page-weights for all N fetched pages plus one page-weight reservoir. (N+1) ×(N+1) square matrix G represents the connectivity graph. Off-diagonal elements of G represent a link connectivity between the pages. In exemplary embodiments, diagonal elements of the matrix G are all equal to zero. The solution vector X is an eigenvector of the matrix G with the eigenvalue one. In principle, the solution vector X may be obtained from solving this matrix equation exactly. In dealing with the World Wide Web, however, the number of total pages N is very large—order of hundreds of millions or even billions—and solving this matrix equation exactly may be impractical in terms of computer memory and CPU time. Thus, an iterative method is employed. Initially, a guess for X in the right-hand-side is made to obtain X in the left-hand-side. In general, the input and output X will not be same and the input is combined with the output X to prepare new input X and iterate this process until the input and the input and output X become self-consistent within the preset tolerance.

The present invention has been described above with reference to exemplary embodiments. It will be apparent to those skilled in the art that various modifications may be made and other embodiments may be used without departing from the broader scope of the invention. Therefore, these and other variations upon the exemplary embodiment are intended to be covered.

What is claimed is:

1. A computer-implemented method of ranking the relevancy of a collection of hypertext pages to a topic specific keyword-based query, comprising:
calculating an analytic rank of a page;
calculating an editorial rank of the page; and
calculating a rank of the page by combining the analytic rank and the editorial rank.

2. The method of claim 1, wherein the analytic rank is a function of an intrinsic rank and an extrinsic rank of the page.

3. The method of claim 2, wherein the intrinsic rank is a function of a content score and a page popularity score of the page.

4. The method of claim 3, wherein the content score is a function of frequency, location, or font size of a keyword in the page.

5. The method of claim 3, wherein the page popularity score of the page is a function of a page-weight of the page and a site-weight of a site.

6. The method of claim 5, wherein the page-weight is defined as a probability of a user visiting the page when traveling in the collection of hypertext pages in a random fashion.

7. The method of claim 5, wherein the page-weight is obtained as a sum of a product of a link-weight of each inbound link to the page and a page-weight of an originating page.

8. The method of claim 5, wherein the page-weight is computed by:
constructing a connectivity graph, which represents the collection of hypertext pages and a link structure between the pages;
adding a page-weight reservoir with virtual inbound links from each of the pages in the collection of hypertext pages and outbound links to a few selected authoritative web pages; and
summing all products of each inbound link-weight with the page-weight of an originating page providing the inbound link.

9. The method of claim 5, further comprising computing the page-weights by:
initializing a page-weight vector to a constant;
constructing a connectivity graph representative of a link structure of the collection of hypertext pages;
computing an output page-weight vector from an input page-weight vector and the connectivity graph; and
comparing the output page-weight vector with the input page-weight vector for convergence, and if convergence is reached, writing the output page-weight vector in a page-weight database, and if not, mixing the input and output page-weight vectors to generate a new input page-weight vector and repeating until convergence is reached.

10. The method of claim 7, wherein the link-weight is defined as a probability of a user randomly choosing the link to visit other pages when traveling in the collection of hypertext pages.

11. The method of claim 7, wherein the link-weight of each inbound links has a uniform value corresponding to a reciprocal of a total number of links outbound from an originating page.

12. The method of claim 7, wherein the link-weight has a variable value, which depends on a number of outbound links, an offset of the link, a size of a paragraph where the link is located, or whether the link is an external or internal link.

13. The method of claim 8, wherein a link-weight of an outbound virtual link to reservoir is a globally fixed value.

14. The method of claim 8, wherein a link-weight of an outbound virtual link to reservoir is a variable value depending on a number of total outbound links.

15. The method of claim 2, wherein the extrinsic rank is a function of an anchor-weight and a page-weight of pages providing inbound links to the page.

16. The method of claim 2, wherein the extrinsic rank is obtained by summing products of an anchor-weight and a page-weight of an originating page providing each inbound link.

17. The method of claim 15, wherein the anchor-weight is a function of inbound link-weights and a keyword being present in an anchor text, in a vicinity of the anchor text, or in text related to a topic of the anchor text.

18. The method of claim 15, wherein the page-weight is defined as a probability of a user randomly visiting a page in the collection of hypertext pages.

19. The method of claim 15, wherein the page-weight is obtained by summing products of a link-weight of each inbound link to the page and the page-weight of an originating page providing the inbound links.

20. The method of claim 15, wherein the page-weight is computed:
constructing a connectivity graph, which represents the collection of hypertext pages and a link structure between the pages;
adding a page-weight reservoir with virtual inbound links from each of the pages in the collection of hypertext pages and outbound links to a few selected authoritative web pages; and
summing all products of each inbound link-weight with the page-weight of an originating page providing the inbound link.

21. The method of claim 15, further comprising computing the page-weights by:
initializing a page-weight vector to a constant;
constructing a connectivity graph representative of a link structure of the collection of pages;
computing an output page-weight vector from an input page-weight vector and the connectivity graph; and
comparing the output page-weight vector with the input page-weight vector for convergence, and if convergence is reached, writing the output page-weight vector in a page-weight database, and if not, mixing the input and output page-weight vectors to generate a new input page-weight vector and repeating until convergence is reached.

22. The method of claim 19, wherein the link-weight is defined as a probability of a user randomly choosing the link to visit other pages when traveling in the collection of hypertext pages.

23. The method of claim 19, wherein the link-weight of the inbound links has a uniform value corresponding to a reciprocal of a total number of links outbound from an originating page.

24. The method of claim 19, wherein the link-weight has a variable value, which depends on a number of outbound links, an offset of the link, a size of a paragraph where the link is located, or whether the link is an external or internal link.

25. The method of claim 1, wherein the collection of hypertext pages is fetched from the Internet.

26. A web search engine, comprising:
a web page database;
a crawler configured to fetch pages from the Internet and store the pages in the web page database;
a URL extractor configured to extract outbound link information from the pages;
a URL management system configured to assign an identification number to a URL of each page, and store the identification number and URL pairs in the web page database and send new URLs to the crawler to be retrieved from the Internet;
a link database;
a link extractor configured to extract anchor text and a link information from the pages and store in the link database;
an index database;
an indexer configured to parse keywords from the pages and store the keyword and URL identification pairs in the index database; and
a ranker configured to rank a page based on analytic rank and editorial rank of the page.

27. The web search engine of claim 26, wherein the ranker is further configured to determine the analytic rank from intrinsic rank and extrinsic rank of the page.

28. The web search engine of claim 27, wherein the ranker is further configured to determine the intrinsic rank from a content score and a page popularity score of the page.

29. The web search engine of claim 28, wherein the ranker is further configured to determine the content score from content information in the index database and the page-popularity computed from the page-weight of a page and site-weight of the site.

30. The web search engine of claim 29, wherein the ranker is further configured to determine the page-weight from link information in the link database, and the extrinsic rank from anchor text information in the link database and the computed page-weight.

31. The web search engine of claim 27, wherein the ranker is further configured to determine the intrinsic rank of the page based on a content score and a page-weight.

32. The web search engine of claim 27, wherein the ranker is further configured to determine the extrinsic rank of the page based on an anchor-weight of each inbound link and a page-weight of the originating page.

33. The web search engine of claim 32, wherein the ranker is further configured to determine the anchor-weight based on a link-weight and a keyword being present in anchor text or related text.

34. The web search engine of claim 27, wherein the ranker is further configured to calculate the intrinsic rank and extrinsic rank of a page for a multi-keyword query, wherein the intrinsic rank is a function of content score and a page-weight, the extrinsic rank of the page is a function of the partial extrinsic ranks and proximity values.

35. The web search engine of claim 27, further comprising a page-weight generator and a page-weight database, the page-weight generator configured to compute page-weights by initializing a page-weight vector to a constant, construct a connectivity graph representing a link structure of the fetched pages, compute an output page-weight vector from the input page-weight vector and the connectivity graph, and compare the output page-weight vector with the input page-weight vector and if convergence is reached, write the output page-weight vector in a page-weight database, and if not, mix the input and output page-weight vectors to generate a new input page-weight vector and repeat until convergence is reached.

36. A computer readable medium having embodied thereon a program, the program being executable by a machine to perform a method for ranking the relevancy of a collection of hypertext pages to a topic specific keyword-based query, the method comprising:
calculating an analytic rank of a page;
calculating an editorial rank of the page; and
calculating a rank of the page by combining the analytic rank and the editorial rank.
